(19) United States
(12) Patent Application Publication
(10) Pub. No.: US 2015/0370412 A1
(43) Pub. Date: Dec. 24, 2015

(54) TOUCH PANEL DEVICE, ELECTRONIC APPARATUS AND METHOD

(71) Applicant: Kabushiki Kaisha Toshiba, Tokyo (JP)

(72) Inventors: Isao Ohba, Tokyo (JP); Saori Michihata, Sagamihara Kanagawa (JP); Toshiya Takano, Sagamihara Kanagawa (JP)

(21) Appl. No.: 14/496,195

(22) Filed: Sep. 25, 2014

Related U.S. Application Data
(60) Provisional application No. 62/016,449, filed on Jun. 24, 2014.

(51) Int. Cl. G06F 3/041; G06F 3/044

(52) U.S. Cl. CPC G06F 3/0418; G06F 3/0412; G06F 3/044

(57) ABSTRACT

According to one embodiment, a capacitance type touch panel device which is provided on a screen of a display device and is allowed to detect a touch of a stylus is provided. The touch panel device includes a loop antenna, a sensor and a controller. The sensor is connected to the loop antenna and is configured to detect noise which generates in accordance with driving of the display device. The controller is configured to detect the touch at timing different from timing in which the noise generates in the cycle of generation of detected noise.

### CROSS-REFERENCE TO RELATED APPLICATIONS

This application claims the benefit of U.S. Provisional Application No. 62/016,449, filed Jun. 24, 2014, the entire contents of which are incorporated herein by reference.

### FIELD

Embodiments described herein relate generally to an touch panel device, an electronic apparatus and a method.

### BACKGROUND

In general, for example, electronic apparatuses such as a smart phone and a table computer, which include capacitance type touch panels, are well known.

Such a capacitance type touch panel can detect a variation of a weak capacitance (quantity of electricity) which generates when a screen is touched by a finger, thereby detect the position of the touched part of the screen. Thus, a user can operate such an electronic apparatus as described above by touching a screen thereof with his or her finger. It is also possible to operate the electronic apparatus with a pen designed for the capacitance type touch panel.

It should be noted that it is necessary to ensure a certain contact area to obtain a capacitance with which a touch can be detected in the capacitance type touch panel. Thus, most pens applicable to the capacitance type touch panel have thick pen points.

On the other hand, in recent years, pens (active stylus pens) have been developed which can each supply a capacitance required to operate a touch panel (sensor), by providing a mechanism which generates static electricity in, e.g., the vicinity of a pen point. Such an active stylus pen can be made to have a pen point which is thinner than such an ordinary pen as described above, thus improving usability.

It should be noted that such an electronic apparatus as described above is provided with a liquid crystal display device (LCD), and when the LCD is driven, noise generates.

In most cases, the noise will give rise to no problem in the case where an operation is performed by a finger. However, there is a case where the noise lowers the precision of detection by the touch panel in the case of using the above pen (especially, the active stylus pen).

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an appearance of an electronic apparatus provided with a touch panel device according to an embodiment;

FIG. 2 is a view showing an example of a system configuration of the electronic apparatus as shown in FIG. 1;

FIG. 3 is a view for use in explaining an example of a mounting structure of the touch panel device;

FIG. 4 is a view for use in explaining an example of a positional relationship between layers included in the touch panel device;

FIG. 5 is a perspective view showing an example of a pattern formed with first electrodes and second electrodes in the touch panel device;

FIG. 6 is a projection view showing the example of the pattern formed with the first and second electrodes in the touch panel device;

FIG. 7 is a flowchart showing a processing procedure of the touch panel device in the case where no touch operation is performed on a screen;

FIG. 8 is a flowchart showing a processing procedure of the touch panel device in the case where a touch operation is being performed on the screen;

FIG. 9 is a view for use in explaining an example of an operation state transition of the touch panel device according to the embodiment; and

FIG. 10 is a view for use in explaining an example of changing of timing of detecting the touch operation.

### DETAILED DESCRIPTION

Various embodiments will be described hereinafter with reference to the accompanying drawings.

In general, according to one embodiment, a capacitance type touch panel device which is provided on a screen of a display device and is allowed to detect a touch of a stylus is provided. The touch panel device includes a loop antenna, a sensor and a controller. The sensor is connected to the loop antenna and is configured to detect noise which generates in accordance with driving of the display device. The controller is configured to detect the touch at timing different from timing in which the noise generates in a cycle of generation of the detected noise.

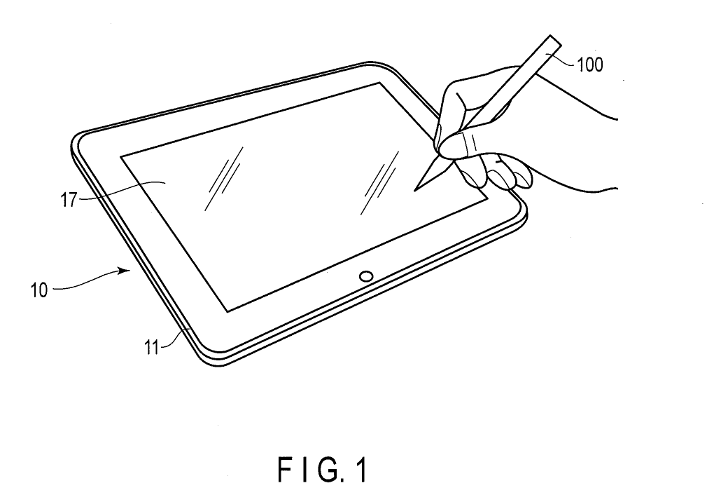

FIG. 1 is a perspective view showing an example of appearance of an electronic apparatus provided with the touch panel device according to the embodiment. The electronic apparatus is a pen-base type portable electronic apparatus which can be operated by a stylus (pen) or a user's finger. The electronic apparatus may be achieved as, e.g., a tablet computer or a smart phone. The following explanation is given with respect to the case where the electronic apparatus is achieved as a tablet computer. It should be noted that the tablet computer is a portable electronic apparatus referred to as a tablet or a slate computer.

As shown in FIG. 1, main body 11 of electronic apparatus 10 includes a housing formed in the shape of a thin box. Also, touch screen display 17 is attached to an upper surface of main body 11 such that it is laid over the upper surface thereof.

Touch screen display 17 incorporates a flat panel display (display device) and a sensor configured to detect contact (position) of, e.g., the user's finger, with an upper surface of a screen of the flat panel display. The flat panel display includes, e.g., a liquid crystal display device (LCD). Furthermore, in the embodiment, as the sensor, for example, a capacitance type touch panel device is used. The capacitance type touch panel device detects variation of a weak capacitance (quantity of electricity) which generates when contact is made with the screen. Thereby, the capacitance type touch panel device can detect contact (position) with the upper surface of the screen, i.e., a touch operation.

Furthermore, the capacitance type touch panel device can detect not only a touch operation by the user's finger on the screen, but a touch operation by pen 100 on the screen. In this case, pen 100 to be applied is a pen designed for a capacitance type touch panel, e.g., a pen (hereinafter referred to as an active stylus pen) which can supply a capacitance required to operate the touch panel, by providing a mechanism which generates static electricity in the vicinity of a point of the pen. Although it is explained above that pen 100 is the pen provided with a mechanism which generates static electricity in the vicinity of the pen point, a pen provided with another mechanism which can supply the capacitance as described above may be applied as pen 100. Also, a pen not provided with such a mechanism as described above may be applied as long as it is designed for the capacitance type touch panel.

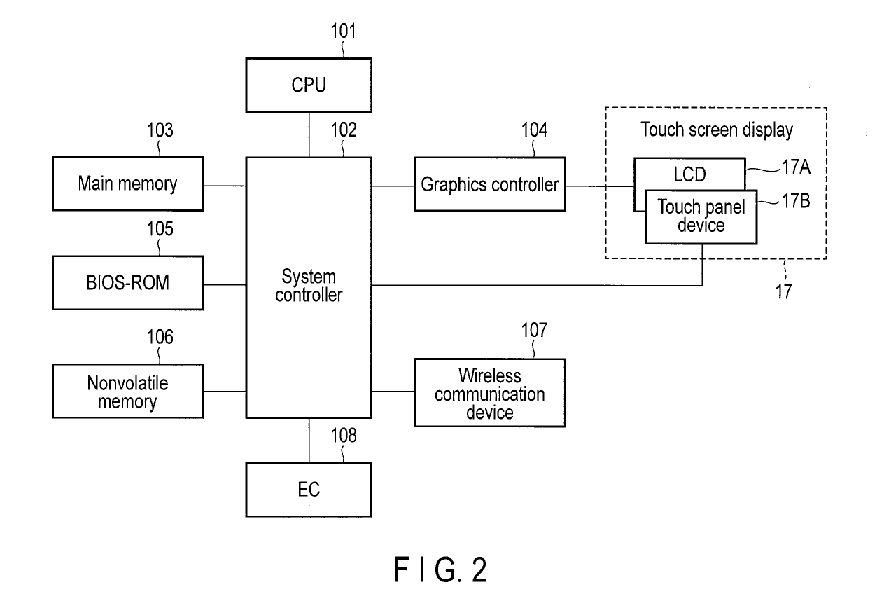

FIG. 2 shows a system configuration of electronic apparatus (tablet computer) 10 as shown in FIG. 1. As shown in FIG. 2, electronic apparatus 10 includes, e.g., CPU 101, system controller 102, main memory 103, graphics controller 104, BIOS-ROM 105, nonvolatile memory 106, wireless communication device 107, EC 108, etc. Also, touch screen display 17 of electronic apparatus 10 as shown in FIG. 1 includes LCD 17A and touch panel device 17B as described above.

CPU 101 is a processor which controls operations of components provided in electronic apparatus 10. CPU 101 executes various software loaded from nonvolatile memory 106, which is a storage device, to main memory 103. The various software includes an operating system (OS) and various application programs.

CPU 101 also executes a basic input output system (BIOS) stored in BIOS-ROM 105. The BIOS is a program for controlling hardware.

System controller 102 is a device which effects connection between a local bus and each of the components. Also, system controller 102 incorporates a memory controller which exerts an access control of main memory 103. Furthermore, system controller 102 has a function of performing communication with graphics controller 104 through, e.g., a serial bus based on PCI EXPRESS standard.

Graphics controller 104 is a display controller which controls LCD 17A used as a display monitor of the electronic apparatus. A display signal produced by graphics controller 104 is sent to LCD 17A. Based on the display signal, LCD 17A displays a screen image. Touch panel device 17B is a capacitance type pointing device which is provided on a screen of LCD 17A, and can detect contact (position) of the user's finger or pen 100 with the screen.

It should be noted that when LCD 17A is driven, noise generates in accordance with the driving of LCD 17A. The noise generates at, e.g., predetermined intervals. Although it will be described later in detail, touch panel device 17B is provided with a detector which detects noise generating in accordance with driving of LCD 17A.

Wireless communication device 107 is a device configured to perform wireless communication such as wireless LAN or 3G mobile communication.

EC 108 is a one-chip microcomputer including an embedded controller for power control. EC 108 has a function of turning on or off a power supply of electronic apparatus 10 in accordance with an operation by a user on a power button.

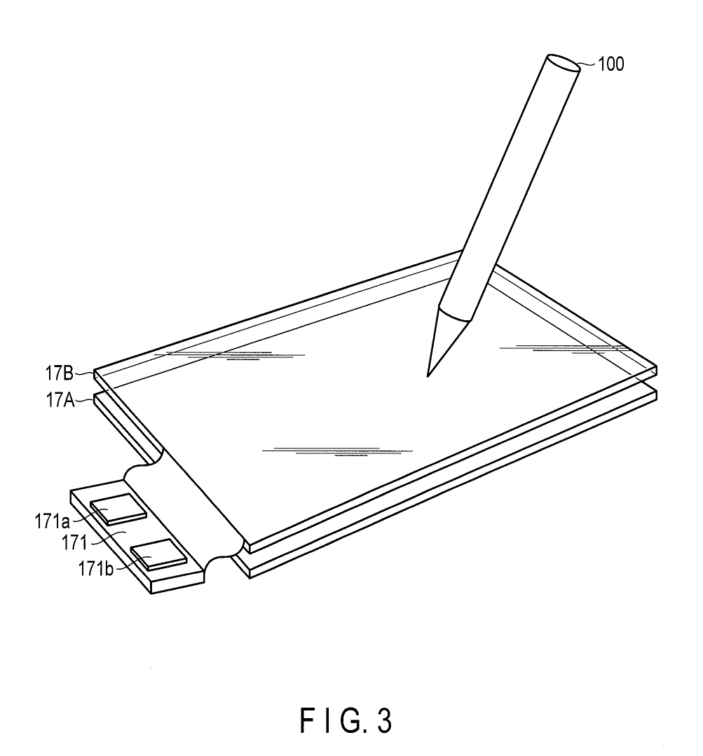

Next, a structure of touch panel device 17B will be explained with reference to FIGS. 3-5. It should be noted that the following explanation is given mainly of a projection capacitance type touch panel device 17B adopting a glass-film film (GFF) system, to which the active stylus pen is applicable. The GFF system is a system including two electrodes (two ITO film sensors) made of cover glass and indium tin oxide (ITO), as described later.

First, with reference to FIG. 3, a mounting structure of touch panel device 17B will be explained. As shown in FIG. 3, touch panel device 17B laid over LCD 17A includes printed circuit board (PCB) 171. On printed circuit board 171, control integrated circuit (IC) 171a and magnetic-field sensor 171b are mounted (provided).

Control IC 171a is a control IC (controller) which controls an operation of entire touch panel device 17B.

Magnetic-field sensor 171b is connected to a loop antenna (loop sensor) for noise detection, not shown in FIG. 3, which is provided in touch panel device 17B. Magnetic-field sensor 171b and the loop antenna form the above detector. Operations of magnetic-field sensor 171b and the loop antenna will be described later.

It should be noted that in the embodiment, although LCD 17A also includes a printed circuit board (PCB) on which a control IC, etc. are mounted, it is a general LCD.

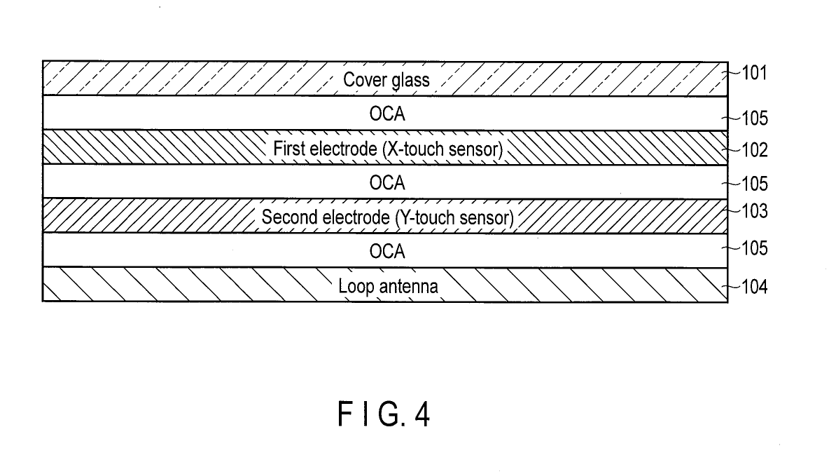

Next, a positional relationship between layers included in touch panel device 17B will be explained with reference to FIG. 4.

As shown in FIG. 4, touch panel device 17B includes first layer 102 to third layer 104 which are stacked under cover glass 101 provided at a surface of touch panel device 17B.

First layer 102 includes first electrodes (X-touch sensors) for detecting contact (touch operation) of the user's finger or pen 100. The first electrodes are electrodes for, e.g., x-coordinate detection.

In second layer 103 located to be laid over first layer 102, second electrodes (Y-touch sensors) for detecting contact (touch operation) of the user's finger or the pen are provided. The second electrodes are electrodes for, e.g., Y-coordinate detection.

It should be noted that the first electrodes and the second electrodes are arranged to form a specific pattern by laying the first layer 102 and the second layer 103 over each other.

In third layer 104, the above loop antenna is provided. The loop antenna is formed of, e.g., minute metal wires. This can reduce a resistance value and improve sensitivity (precision) of sensing.

It should be noted that cover glass 101 and first layer 102 are bonded to each other by a film adhesive sheet referred to as an optical clear adhesive (OCA). Similarly, first layer 102 and second layer 103 are bonded by OCA and second layer 103 and third layer 104 are also bonded by OCA.

Furthermore, although it is omitted in FIG. 4, LCD 17A is provided under third layer 104 (i.e., the loop antenna), with OCA or air space interposed between them. To be more specific, in the embodiment, the loop antenna is provided in third layer 104, which is located closer to LCD 17A than first layer 102 and second layer 103.

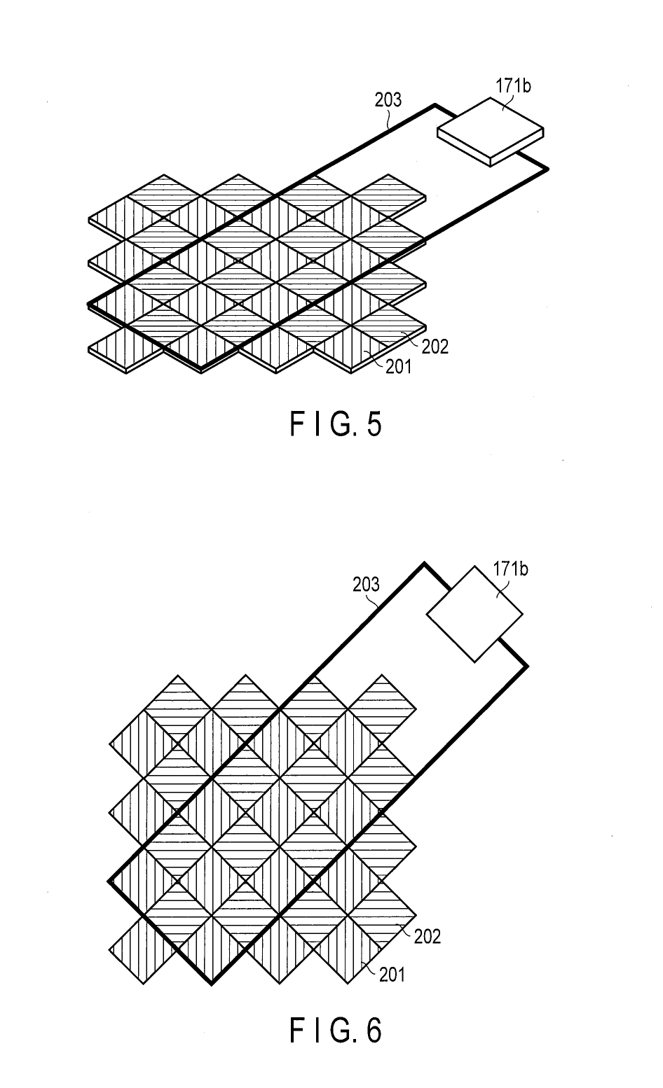

Next, with reference to FIGS. 5 and 6, the pattern formed with the first electrodes and the second electrodes in touch panel device 17B will be explained.

Referring to FIGS. 5 and 6, first electrodes 201 and second electrodes 202, as described above, provided in different layers (corresponding to first layer 102 and second layer 103) form a specific pattern (diamond pattern) on touch panel device 17B. In touch panel device 17B, since first electrodes 201 and second electrodes 202 form such a pattern, it is possible to detect the position of the user's finger or pen 100 contacting the screen by measuring capacitance between the electrodes, which varies upon the contact of the user's finger or pen 100.

Referring to FIGS. 5 and 6, loop antenna 203 provided in third layer 104 is formed in a loop, and is provided in a position overlapping with a diamond pattern formed with first electrodes 201 and second electrodes 202. To be more specific, loop antenna 203 has such a thickness as exerts no influence over visibility under which the user views the screen, and is located in space in a pattern formed with the first electrodes 201 and the second electrodes 202. Also, loop antenna 203 is connected to magnetic-field sensor 171b described above.

It should be noted that although it is not shown, loop antenna 203 is configured to be connectable to ground (GND).

An operation of touch panel device 17B according to the embodiment will be explained.

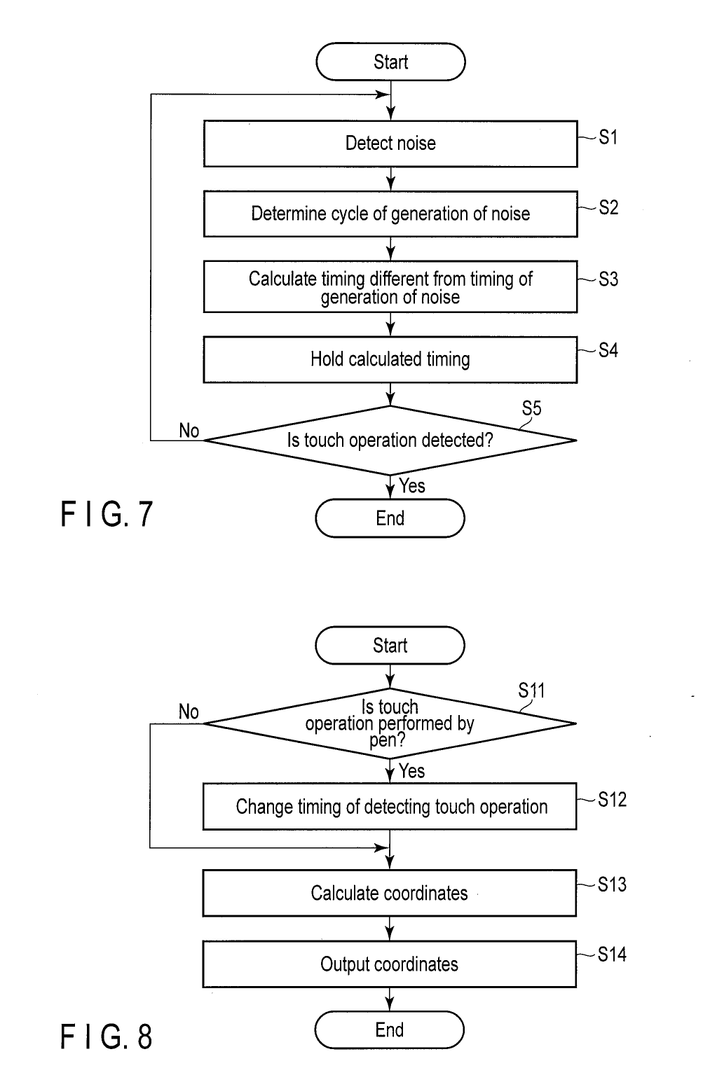

First of all, with reference to the flowchart of FIG. 7, a processing procedure of touch panel device 17B in the case where a touch operation is not performed on the screen (i.e., contact of the user's finger or pen 100 is not detected) will be explained. A state of touch panel device 17B in which no touch operation is performed on the screen will be hereinafter referred to as an idle state. Also, suppose loop antenna 203 is not connected to GND while touch panel device 17B is in the idle state.

In this case, loop antenna 203, which is provided in touch panel device 17B, detects noise which generates in accordance with driving of LCD 17A (step S1). To be more specific, loop antenna 203 generates current due to variation of a magnetic field (i.e., magnetic-field noise) which is caused by the noise generating in accordance with the driving of LCD 17A. The current generated by loop antenna 203 is converted into an electric signal by magnetic-field sensor 171b, and input to control IC 171a. It should be noted that while electronic apparatus 10 is in the idle state, the noise is detected each time it generates.

Next, control IC 171a determines a cycle of generation of noise (rewriting timing of LCD 17A) based on the input electric signal (i.e., the noise detected by loop antenna 203) (step S2). Based on the determined cycle of generation of noise, control IC 171a calculates timing (hereinafter referred to as a sensing timing) at which a touch operation on the screen (contact with the screen) is to be detected. In this case, control IC 171a calculates as the sensing timing, timing different from timing at which noise generates from LCD 17A in the cycle of generation of noise (step S3).

In such a manner, the sensing timing calculated by control IC 171a is held in a holding module provided in touch panel device 17B.

Touch panel device 17B, as described above, can detect a touch operation (contact of the user's finger or pen 100) on the screen by measuring capacitance between first electrodes 201 and second electrodes 202. Control IC 171a determines whether a touch operation is detected at touch panel device 17B (step S5).

If it is determined that no touch operation is detected (No in step S5), the step to be carried out is returned to step S1, and the above steps are repeated.

On the other hand, if it is determined that a touch operation is detected, processing as shown in FIG. 8, which will be explained as follows, is executed.

As described above, it is possible to calculate and hold timing different from that at which noise generates from LCD 17A (i.e., timing at which the noise has no influence upon the detection), by executing processing as shown in FIG. 7 when touch panel device 17B is in the idle state.

Furthermore, the processing as shown in FIG. 7 is repeatedly executed when touch panel device 17B is in the idle state. Thus, in the case where the newest sensing timing is calculated in step S3, it is held in the holding module (that is, the sensing timing is updated).

Next, with reference to the flowchart of FIG. 8, a processing procedure of touch panel device 17B in the case where the touch operation is being performed on the screen (a touch of the user's finger or pen 100 is detected) will be explained. It should be noted that a state of touch panel device 17B in which a touch operation is being performed on the screen will be hereinafter referred to as a touch state.

While touch panel device 17B is in the touch state, loop antenna 203 is connected to GND, and it does not perform detection (noise sensing) of noise which generates in accordance with driving of LCD 17A. It should be noted that loop antenna 203, as described above, is provided between LCD 17A and first electrodes 201 (i.e., first layer 102) and second electrodes 202 (i.e., second layer 103) (that is, it is provided in third layer 104, which is located closer to LCD 17A than first layer 102 and second layer 103). Thus, in the case where loop antenna 203 is connected to GND, third layer 104, in which loop antenna 203 is provided, functions as, e.g., an electromagnetic shield which prevents the influence of noise from LCD 17A upon first electrodes 201 and second electrodes 202.

First, controller IC 171a provided in touch panel device 17B determines whether the touch operation detected at touch panel device 17B is a touch operation by pen 100 or not (step S11).

The above determination processing in step S11 will be specifically explained. It should be noted that as the active stylus pen, an active stylus pen which can output an active signal to touch panel device 17B when being brought into contact with the screen is present. If such an active stylus pen is used as pen 100, it is possible to determine whether or not the detected touch operation is a touch operation by pen 100, in accordance with whether pen 100 outputs a signal or not. Furthermore, as described above, it is possible to detect the touch operation by measuring capacitance between first electrodes 201 and second electrodes 202. In this case, since the capacitance (variation amount) varies in accordance with whether the touch operation is a touch operation by the user's finger or a touch operation by pen 100, it is also possible to determine, based on the capacitance, whether the touch operation is a touch operation by the user's finger or a touch operation by pen 100. In addition, in general, in the case where the touch operation is a touch operation by pen 100, the area of part of the screen, which is contacted by pen 100, is smaller than that in the case where the touch operation is a touch operation by the user's finger. It is therefore possible to determine whether the touch operation is a touch operation by the user's finger or a touch operation by pen 100, based on distribution of capacitance (electric charge) which varies in accordance with which touch operation is performed.

When it is determined by the above determination processing that the touch operation is a touch operation by pen 100 (Yes in step S11), control IC 171a changes timing at which a touch operation is detected at touch panel device 17B from the present timing to the sensing timing held in the holding module (step S12). As a result, control IC 171a can cause touch panel device 17B to operate in a mode (scan mode) synchronizing with the sensing timing held by the holding module. In this case, control IC 171a detects a touch operation at timing different from timing at which noise generates from LCD 17A in a cycle of generation of noise.

Next, based on positions of the first and second electrodes 201 and 202, which are simultaneously varied in capacitance by a touch operation, control IC 171a calculates a position (i.e., coordinates) of part of the screen, on which the touch operation is performed (step S13).

Control IC 171a outputs the calculated coordinates (step S14). The coordinates output by control IC 171a (touch panel device 17B) are sent to CPU 101, and applied to various kinds of processing to be executed in electronic apparatus 10.

On the other hand, when it is determined that the touch operation is not a touch operation by pen 100 (that is, it is a touch operation by the user's finger) (No in step S11), processing of step S12 is not executed, and processing of step S13 is executed.

As described above, when touch panel device 17B is in the touch state, the processing as shown in FIG. 8 is executed, and as a result in the case where the touch operation on the screen is a touch operation by pen 100, the timing at which a touch operation is detected is changed from the present timing to the sensing timing calculated (held) in the processing as shown in FIG. 7.

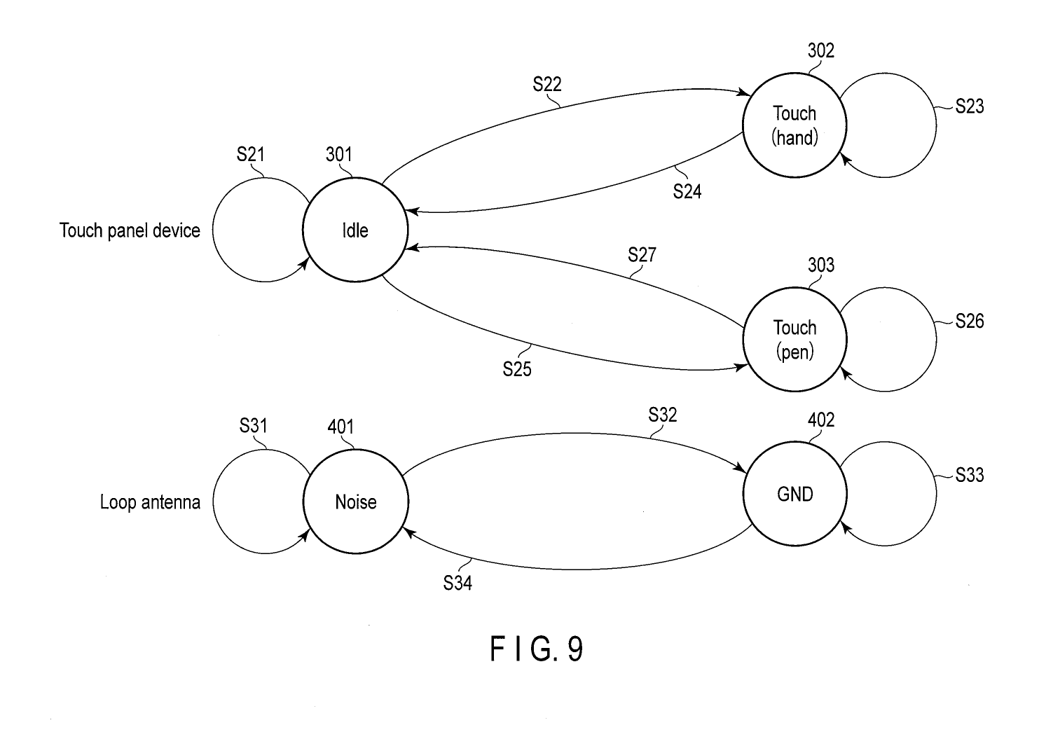

Next, with reference to FIG. 9, an operation state transition of the touch panel device 17B according to the embodiment will be explained. FIG. 9 show the operation state transition of touch panel device 17B and loop antenna 203.

In FIG. 9, idle state 301, touch (hand) state 302 and touch (pen) state 303 are operation states of touch panel device 17B. Idle state 301 is an operation state of touch panel device 17B in which no touch operation is performed on the screen as stated above. On the other hand, touch (hand) state 302 is an operation state of touch panel device 17B in which a touch operation by the user's finger is performed on the screen. Touch (pen) state 303 is an operation state of touch panel device 17B in which a touch operation by pen 100 is performed on the screen.

First, in the case where touch panel device 17B is in idle state 301, idle state 301 continues until a touch operation by the user's finger or pen 100 on the screen is detected (step S21). It should be noted that in idle state 301, the cycle of detection for touch is relatively long, as compared with those in touch (hand) state 302 and touch (pen) state 303.

The following explanation is given with respect to the case wherein when touch panel device 17B is in idle state 301, a touch operation by the user's finger is performed. In this case, the operation state of touch panel device 17B changes from idle state 301 to touch (hand) state 302 (step S22). Touch (hand) state 302 is maintained while a touch operation by the user's finger on the screen continues (step S23). It should be noted that in touch (hand) state 302, the cycle of detection for touch (touch of the user's finger in this case) is relatively short, as compared with that in idle state 301.

In the case where touch panel device 17B is in touch (hand) state 302, when the touch operation by the user's finger ends, the operation state of touch panel device 17B is returned from touch (hand) state 302 to idle state 301.

On the other hand, in the case where touch panel device 17B is in idle state 301, when a touch operation by pen 100 is performed, the operation state of touch panel device 17B changes from idle state 301 to touch (pen) state 303 (step S25). Touch (pen) state 303 is maintained while the touch operation by pen 100 on the screen continues (step S26). It should be noted that in touch (pen) state 303, although intervals of detection of a touch operation (a touch operation by pen 100 in this case) is the same as that in touch (hand) state 302, the timing of detection of a touch operation is changed from the present timing to the sensing timing calculated in the processing as shown in FIG. 7.

In the case where touch panel device 17B is in touch (pen) state 303, when the touch operation by pen 100 ends, the operation state of touch panel device 17B is returned from touch (pen) state 303 to idle state 301.

In FIG. 9, noise state 401 and GND state 402 are operation states of loop antenna 203. Noise state 401 is a state in which loop antenna 203 is not connected to GND, and can detect noise which generates in accordance with driving of LCD 17A. GND state 402 is a state in which loop antenna 203 is connected to GND. It should be noted that the operation state of loop antenna 203 changes in accordance with the above changing of the operation state of touch panel device 17B.

In the case where touch panel device 17B is in idle state 301, as described above, loop antenna 203 needs to detect noise from LCD 17A, and thus the operation state of loop antenna 203 is noise state 401. Noise state 401 continues while touch panel device 17B is in idle state 301 (step S31).

In the case where touch panel device 17B is in idle state 301, when a touch operation by the user's finger or pen 100 is performed, the operation state of touch panel device 17B changes from idle state 301 to touch (hand) state 302 or touch (pen) state 303. In this case, the operation state of loop antenna 203 changes from noise state 401 to GND state 402. That is, in the case where touch panel device 17B is in touch (hand) state 302 or touch (pen) state 303, loop antenna 203 is connected to GND, and third layer 104, in which loop antenna 203 is provided, functions as an electromagnetic shield. GND state 402 continues while touch panel device 17B is in touch (hand) state 302 or touch (pen) state 303 (step S33).

In the case where touch panel device 17B is in touch (hand) state 302 or touch (pen) state 303, when the touch operation by the user's finger or pen 100 ends, the operation state of touch panel device 17B changes from touch (hand) state 302 or touch (pen) state 303 to idle state 301. In this case, the operation state of loop antenna 203 is returned from GND state 402 to noise state 401.

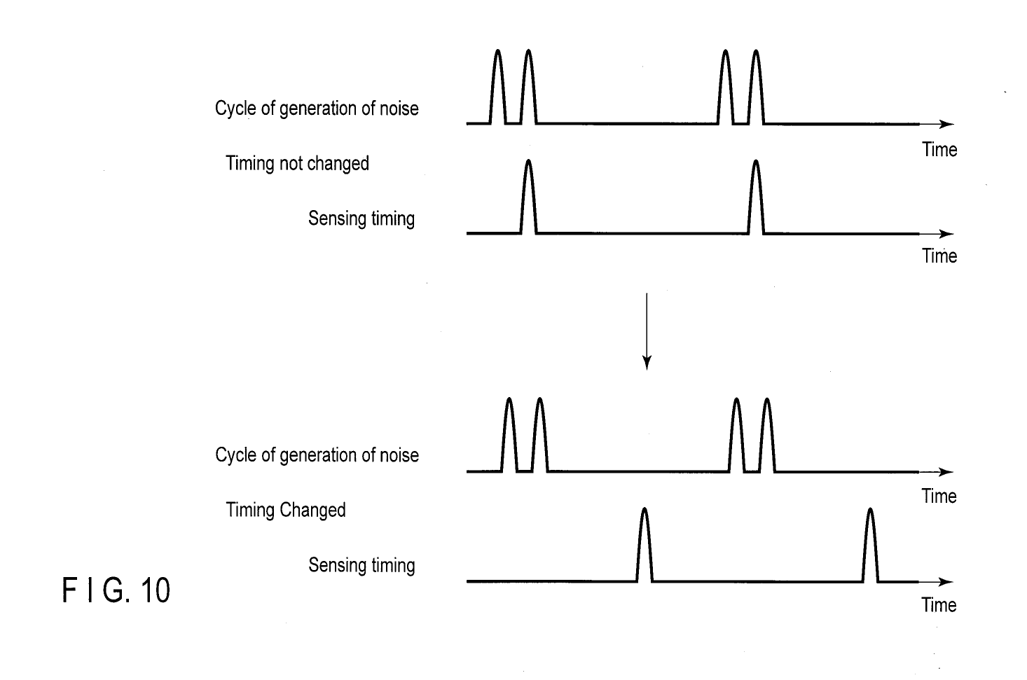

As described above, in the embodiment, by virtue of the structure for detecting noise generating in accordance with driving of LCD 17A and also detecting a touch operation at timing different from timing at which noise generates in a cycle of generation of noise, it is possible to restrict lowering of the precision of detection, which would occur due to the noise, without, e.g., customization of LCD 17A which will increase the cost. That is, the timing of detecting a touch operation is changed from the present timing to such a timing (sensing timing) as shown in FIG. 10, as a result of which in the case where the touch operation by pen 100 is continuously performed, it is detected at timing different from timing at which noise generates from LCD 17A, thus enabling the touch operation to be detected without being affected by the noise from LCD 17A.

Also, in the embodiment, by virtue of the above structure for updating the sensing timing, the timing can be automatically adjusted (i.e., automatic calibration can be performed), as a result of which even if the cycle of generation of noise changes as time passes, it is appropriately handled, and the timing of detecting a touch operation can be controlled at a higher precision.

Furthermore, in the structure according to the embodiment, since noise is detected while no touch operation is detected (i.e., while the idle state 301 as shown in FIG. 9 continues), it is possible to prevent the processing executed in detection of the noise from interfering with the operation performed in touch (hand) state 302 or touch (pen) state 303.

In the embodiment, in the case where a touch operation by pen 100 is detected, the following change is made: the timing of detecting a touch operation is changed from the present timing to timing different from timing at which noise generates, and in the case where a touch operation by the user's finger is detected, the above change is not made. This is because detection of the touch operation by pen 100, for example, an active stylus pen, is more easily affected by noise than that of the touch operation by the user's finger. In the embodiment, by virtue of the above structural feature, it is possible to improve the precision of detection of a touch operation by pen 100, and reduce the amount of processing required in the case where a touch operation by the user's finger is detected. It should be noted that it may be set that also in the case where a touch operation by the user's finger is detected, the timing of detection of a touch operation is changed.

In the embodiment, since loop antenna 203 is provided in third layer 104 located closer to LCD 17A than first layer 102 (first electrodes 201) and second layer 103 (second electrodes 202), it is possible to more precisely detect noise which generates in accordance with driving of LCD 17A.

In addition, in the embodiment, loop antenna 203 is provided in a position overlapping with a diamond pattern of the first and second electrodes 201 and 202, and while a touch operation by pen 100 is being detected, loop antenna 203 is connected to GND. By virtue of such a structural feature, in the embodiment, while the touch operation by pen 100 is being detected, third layer 104, in which loop antenna 20 is provided, can be made to function as an electromagnetic shield, thus restrict the influence of noise from LCD 17A.

It should be noted that with respect to the embodiment, although it is explained above that loop antenna 203 is provided in a layer different from layers in which first electrodes 201 and second electrodes 202 are provided, loop antenna 203 may be provided, for example, in first layer 102 in which first electrodes 201 are provided, or in second layer 103 in which second electrodes 202 are provided. In this case, loop antenna 203 may be provided in the vicinity of first electrodes 201 or second electrodes 202 such that it has no influence upon detection of a touch operation on first electrodes 201 and second electrodes 202. By virtue of such a structural feature, although loop antenna 203 (third layer 104 in which loop antenna 203 is provided) cannot be made to function as the above electromagnetic shield, touch panel device 17B can be made thinner as it is not necessary to provide third layer 104.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A capacitance type touch panel device which is provided on a screen of a display device, and is allowed to detect a touch of a stylus, the touch panel device comprising:
a loop antenna;
a sensor connected to the loop antenna and configured to detect noise which generates in accordance with driving of the display device; and
a controller configured to detect the touch at timing different from timing in which the noise generates in a cycle of generation of the detected noise.

2. The touch panel device of claim 1, wherein the controller comprises:
a holding module configured to hold the timing different from the timing in which the noise generates; and
an update module configured to update the timing held in the holding module,
wherein the controller is configured to detect the touch at the timing held in the holding module.

3. The touch panel device of claim 1, wherein the sensor is configured to detect the noise while the touch of the stylus is undetected.

4. The touch panel device of claim 1, wherein the controller is configured to change timing of touch detection from present timing to timing different from timing at which the noise generates in a cycle of generation of noise, if the touch of the stylus is detected, and make no change to the timing different from timing at which the noise generates of the touch detection, if a touch of a user's finger is detected.

5. The touch panel device of claim 1, further comprising:
first and second electrodes configured to detect the touch of the stylus,
wherein the first electrodes are provided in a first layer,
the second electrodes are provided in a second layer located to be laid over the first layer, and
the loop antenna is provided in a third layer located closer to the display device than the first and second layers.

6. The touch panel device of claim 5, wherein the first and second electrodes are arranged in a specific pattern, and
the loop antenna is provided in a position overlapping with the specific pattern, and is configured to be connected to ground while the touch of the stylus is being detected.

7. The touch panel device of claim 1, further comprising:
first and second electrodes configured to detect the touch of the stylus,
wherein the first electrodes are provided in a first layer,
the second electrodes are provided in a second layer located to be laid over the first layer, and
the loop antenna is provided in vicinity of the first electrodes provided in the first layer or the second electrodes provided in the second layer.

8. An electronic apparatus comprising: a display device; and a capacitance type touch panel device provided on a screen of the display panel and allowed to detect a touch of a stylus,
wherein the touch panel device comprises:
a loop antenna;
a sensor connected to the loop antenna and configured to detect noise which generates in accordance with driving of the display device; and
a controller configured to detect the touch at timing different from timing in which the noise generates in a cycle of generation of the detected noise.

9. A method to be executed by a capacitance type touch panel device provided on a screen of a display device and allowed to detect a touch of a stylus, the method comprising:
detecting noise which generates in accordance with driving of the display device; and
detecting the touch at timing different from timing in which the noise generates in a cycle of generation of the detected noise.
